(19) United States
(12) Patent Application Publication
(10) Pub. No.: US 2025/0300375 A1
(43) Pub. Date: Sep. 25, 2025

(54) TWINAX CONNECTOR FOR PREFERRED BEND CONFIGURATIONS

(71) Applicant: Molex, LLC, Lisle, IL (US)

(72) Inventors: Bruce Reed, Maumelle, AR (US); Michael Garrison, Russellville, AR (US); Gianni Bardella, Maumelle, AR (US)

(21) Appl. No.: 18/863,346

(22) PCT Filed: May 12, 2023
(86) PCT No.: PCT/IB2023/054929

§ 371 Date: Nov. 6, 2024

Related U.S. Application Data
(60) Provisional application No. 63/342,265, filed on May 16, 2022.

(51) Int. Cl. H01R 12/53

(52) U.S. Cl. CPC H01R 12/53

(57) ABSTRACT

A twinax cable assembly comprising twinax cable sets is described. The assembly includes a connector housing a portion of the twinax cable sets. The connector has a connector shell which houses a connector printed circuit board (PCB) that is connected to rows of twinax cables at a cable end section and a condensing cable tie bar through which the rows of twinax cables exit the connector shell in a vertical configuration. In the vertical configuration, the lateral direction of the twinax cables is generally perpendicular to a top or bottom surface of the connector printed circuit board.

### CROSS-REFERENCE TO RELATED APPLICATION

This application claims the benefit of and priority to U.S. Provisional Patent Application No. 63/342,265 filed on May 16, 2022, entitled “TWINAX CONNECTOR FOR PREFERRED BEND CONFIGURATIONS,” the contents of which being incorporated by reference in their entirety herein.

### BACKGROUND

Twinaxial cabling, also referred to generally as “twinax,” is a type of electrical cable similar to coaxial cable, but with two inner conductors instead of one. Twinax is employed in modern very-short-range high-speed differential signaling applications. Signals are sent differentially over the wires at 1 Mbit/s (1 μs/bit±2%). Twinax is typically used in short-range, high-speed applications and can be designed to meet established signal integrity performance standards.

Twinax cables can be assembled in bundles that terminate at connectors at opposite ends of the cable bundle. A cross-section of the ends of the cable bundles can form a two-dimensional array where each cable end terminates on a printed circuit board disposed in the connector. The printed circuit board can be encased in a connector shell or housing with conductors on an edge of the printed circuit board, or metallic contacts exposed on the end of the connector that connects to a receptacle configured to mate with the connector. In some installations, multiple bundles of cables each having connectors may be connected to a backplane on computer components.

### BRIEF SUMMARY OF THE INVENTION

In a first aspect, a twinax cable assembly is described, including a plurality of twinax cable sets, each comprising a plurality of twinax cables, each twinax cable comprising a first conductor spaced apart from a second conductor, each of the twinax cable sets having opposite cable end sections corresponding to first and second assembly ends, and connector ends where each of the twinax cables in the twinax cable sets connect to a terminal component; a connector having a portion of the plurality of twinax cable sets housed therein, the connector having a connector shell having a connector printed circuit board connected to rows of twinax cables at the connector ends; and a condensing cable tie bar through which the rows of twinax cables exit the connector shell in a vertical configuration, wherein, in the vertical configuration, the lateral direction of the twinax cables is generally perpendicular to a top or bottom surface of the connector printed circuit board.

The connector further comprises a horizontal tie bar downstream of the connector printed circuit board for maintaining the rows of twinax cables in a horizontal configuration, wherein the connector ends of the twinax cables are coupled to the connector printed circuit board in the horizontal configuration. The connector further comprises a vertical tie bar downstream from the horizontal tie bar for maintaining the rows of twinax cables in a vertical position. Each twinax cable comprises a pair of ground wires disposed on opposite sides of the pair of conductors, the pair of conductors and pair of ground wires spaced apart in the lateral direction.

The pair of conductors at the connector ends of each twinax cable set connect to the connector printed circuit board in a row of connections substantially in parallel with the row of connections at which the connector ends of a next twinax cable set connects to the connector printed circuit board. The first conductor and the second conductor are spaced apart from one another in a lateral direction. The condensing cable tie bar and the horizontal tie bar are each formed of an injection-molded polymer material.

In a second aspect, a twinax cable assembly is described, including: a plurality of twinax cable sets, each comprising a plurality of twinax cables, each twinax cable comprising a first conductor spaced apart from a second conductor and surrounded by an insulating material, each of the twinax cable sets having opposite cable end sections corresponding to first and second assembly ends, and connector ends where each of the twinax cables in the twinax cable sets connect to a terminal component; a connector housing a portion of the plurality of twinax cable sets, the connector having a connector shell which houses a termination structure connected to rows of twinax cables at a cable end section and a condensing cable tie bar through which the rows of twinax cables exit the connector shell in a vertical configuration, wherein in the vertical configuration, the lateral direction of the twinax cable is generally perpendicular to a top or bottom surface of the termination structure.

The termination structure is a connector printed circuit board. The connector further comprises a horizontal tie bar downstream of the connector printed circuit board for maintaining the rows of twinax cables in a horizontal configuration. The connector further comprises a vertical tie bar downstream from the horizontal tie bar for maintaining the rows of twinax cables in a vertical position. Each twinax cable comprises a pair of ground wires disposed on opposite sides of the pair of conductors, the pair of conductors and pair of ground wires spaced apart in the lateral direction.

The pair of conductors at the connector ends of each twinax cable set connect to the connector printed circuit board in a row of connections substantially in parallel with the row of connections at which the connector ends of a next twinax cable set connects to the connector printed circuit board. The first conductor and the second conductor are spaced apart from one another in a lateral direction. The condensing cable tie bar and the horizontal tie bar are each formed of an injection-molded polymer material.

In a third aspect, a twinax cable assembly is described, including: a plurality of twinax cable sets, each comprising a plurality of twinax cables, each twinax cable comprising a first conductor spaced apart from a second conductor and surrounded by an insulating material, each of the twinax cable sets having opposite cable end sections corresponding to first and second assembly ends, and connector ends where each of the twinax cables in the twinax cable sets connect to a terminal component; a connector housing a portion of the plurality of twinax cable sets, the connector having a connector shell which houses a termination structure connected to rows of twinax cables at a cable end section; a vertical tie bar through which the rows of twinax cables exit in a vertical configuration disposed in the connector housing; and a horizontal tie bar through downstream of the vertical tie bar which the rows of twinax cables exit in a horizontal configuration disposed in the connector housing, wherein the plurality of twinax cables are coupled to the termination structure in the horizontal configuration.

The termination structure is a connector printed circuit board, and further comprising: a condensing cable tie bar disposed in the connector housing through which the rows of twinax cables exit the connector shell in a vertical configuration. Each twinax cable comprises a pair of ground wires disposed on opposite sides of the pair of conductors, the pair of conductors and pair of ground wires spaced apart in the lateral direction.

The pair of conductors at the connector ends of each twinax cable set connect to the connector printed circuit board in a row of connections substantially in parallel with the row of connections at which the connector ends of a next twinax cable set connects to the connector printed circuit board. The first conductor and the second conductor are spaced apart from one another in a lateral direction, and the vertical tie bar and the horizontal tie bar are each formed of an injection-molded polymer material.

In additional aspects, methods for forming or otherwise providing the foregoing twinax cable assemblies are described.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A is a front perspective cross-sectional view of a twinax cable.

FIG. 1B is a side view of a twinax cable being bent about a lateral axis.

FIG. 1C is a top view of a twinax cable being bent about a depth axis.

FIG. 1D is a partial rear perspective view of a twinax cable connector.

FIG. 2 is a front perspective view of a twinax cable assembly configured for routing with horizontal bends without substantial degradation of signal integrity according to various embodiments of the present disclosure.

FIG. 3 is a rear perspective view of a twinax cable assembly configured for routing with horizontal bends without substantial degradation of signal integrity according to various embodiments of the present disclosure.

### DETAILED DESCRIPTION

A twinax cable assembly comprising twinax cable sets is described. Each cable set includes a plurality of twinax cables. Each twinax cable includes a first conductor spaced apart from a second conductor in a lateral direction and surrounded by an insulating material. Each of the twinax cable sets has opposite cable end sections corresponding to the first and second assembly ends and connector ends where each of the twinax cables in the twinax cable sets connect to a terminal component.

The assembly also includes a connector housing a portion of the plurality of twinax cable sets. The connector has a connector shell which houses a connector printed circuit board or other termination device connected to rows of twinax cables at a cable end section and one or more condensing cable tie bar through which the rows of twinax cables exit the connector shell in either a vertical configuration or a horizontal configuration, as will be described. In the vertical configuration, for example, the lateral direction of the twinax cable is generally perpendicular to a top or bottom surface of the connector printed circuit board. In the horizontal configuration, for example, the lateral direction of the twinax cable is generally parallel to a top or bottom surface of the connector printed circuit board.

As noted above, in some installations, multiple bundles of cables each having connectors may be connected to a backplane on computer components. Each cable bundle or cable assembly may need to be bent in tight spaces such that the bend may be a tight bend or a sharp-angled bend. A sufficiently tight bend may affect the signal integrity of the signals being communicated in the twinax cables. The bend may be sufficient so as to cause failure of the performance standards for signal integrity at bends.

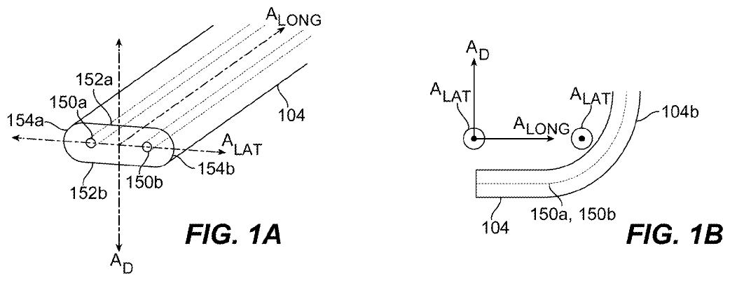

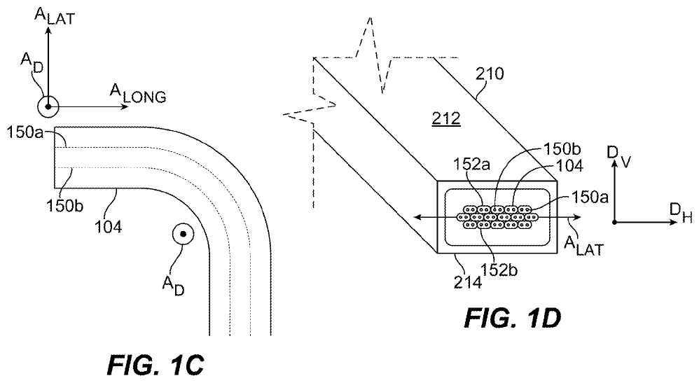

With reference to FIG. 1A, a twinax cable 104 includes two generally round conductors 150a, 150b (collectively “conductors 150”) arranged side-by-side, thereby forming a generally oval-shaped cross section with a pair of opposing flat sides 152a, 152b and a pair of opposing generally curved sides 154a, 154b. The conductors 150 within the twinax cable 104 flow or are arranged in a generally longitudinal direction along a longitudinal axis A_{LONG}. A lateral axis A_{LAT} is formed in a lateral direction from a first conductor 150a to a second conductor 150b, as shown in FIG. 1A. Further, a depth axis A_{D} is formed in a depth direction perpendicular to both the longitudinal axis A_{LONG} and the lateral axis A_{LAT} and generally from the top flat side 152a to the bottom flat side 152b.

In implementations in which the twinax cable 104 is used in a connector shell, as will be described, the twinax cable 104 may be bent about either the lateral axis A_{LAT} or the depth axis A_{D}. One cause of the degradation of signal integrity at tight bends of twinax cable assemblies occurs when a twinax cable 104, or bundle of twinax cables, bends such that the pair of the conductors 150 in the cable is aligned perpendicular to an axis around which the cable 104 is bent, which occurs when the cable 104 is bent along the depth axis A_{D}, as shown in FIG. 1C.

In such a bend, called a bad-way bend, the first conductor 150a, namely the outside conductor 150, is disposed further from a bending axis (A_{D}) around which the cable 104 is bent than the second conductor 150b, namely the inside conductor 150, which is disposed closer to the bending axis (A_{D}), in this case the depth axis A_{D}. Such a bend has been shown to cause a lengthening in the timing of the signal traveling along the outside conductor 150a relative to the timing of the signal traveling along the inside conductor 150b. Such a lengthening in the timing between the differential signals degrades the signal integrity and can compromise the ability of the cable 104 to perform within the signal integrity specifications typically specified for cable bends.

With reference to FIG. 1B, the twinax cable 104, or bundle of twinax cables, bends along the lateral axis A_{LAT}, and the pair of the conductors 150 in the cable are aligned to the axis around which the cable 104 is bent. In such a bend, called a good-way bend, both conductors 150a, 150b are disposed equidistant from the bending axis (A_{LAT}) around which the cable 104 is bent, in this case the lateral axis A_{LAT}. Such a bend has been shown to minimize or eliminate any lengthening in the timing of the signal traveling in conductor 150a relative to the timing of the signal traveling along conductor 150b, which results in a cleaner signal than that which occurs due to a bad-way bend, shown in FIG. 1C.

With reference to FIG. 1D, when a bundle of twinax cables 104 exits from a connector shell 210, each twinax cable 104 exits in a horizontal configuration, whereby the lateral axis A_{LAT} of the cable 104 is generally parallel with top or bottom surfaces 212, 214 of the connector shell 210 and/or top or bottom surfaces of a connector printed circuit board (not shown). The reason for this is that typically each cable is mounted on a surface of the printed circuit board in a horizontal configuration and the cable 104 maintains this configuration while in the connector shell 210.

In this horizontal configuration, a good-way bend is only permissible by bending the cable either up or down, for instance, in a vertical direction D_{V} and not in a horizontal direction D_{H}. The vertical direction is a direction that goes from the top surface 212 of the connector shell 210 to the bottom surface 214 of the connector shell 210. The horizontal direction D_{H} is perpendicular to the vertical direction D_{V}. This limits the direction the bundle of twinax cables 104 may go when exiting the connector shell 210 as either going upwards or downwards along the vertical direction D_{V}, but not left or right along the horizontal direction D_{H}.

However, it is desirable in some situations that the bundle of twinax cables 104 turn either left or right and travel in the horizontal direction D_{H} when exiting the connector shell 210 without degrading the signal integrity and compromising the ability of the cables 104 to perform within the signal integrity specifications typically specified for cable bends.

Example implementations of a twinax cable assembly 100 described herein address the possible degradation of signal integrity when twinax cable assemblies 100 are bent, particularly near a connection to an electrical component. As is understood, twinax cables 104 include a pair of conductors 150 surrounded by an insulating material within a cable covering or sheath. Twinax cables 104 are an alternative to twisted pair cables and other schemes configured to conduct differential electrical signals. Twinax cables 104 are designed to benefit from the same structural characteristics that improve signal integrity in coaxial cables in which a signal conductor 150 extends through the length of the cable 104. In particular, twinax cables 104 may be surrounded as mentioned above with selected insulating materials including plastic such as polyethylene, foam, and other suitable dielectric materials having sufficient strength and flexibility to keep the conductors separated within the cable and to bend with the bending of the cable assembly.

One cause of the degradation of signal integrity at tight bends of twinax cable 104 assemblies occurs when a cable bends such that the conductor pair 105 in the cable 104 is aligned perpendicular to the axis around which the cable 104 is bent. In such a bend, called a bad-way bend, one conductor 150, the outside conductor, is disposed further from a bending axis around which the cable 104 is bent than the inside conductor, which is disposed closer to the bending axis, as shown in FIG. 1C. Such a bend has been shown to cause a lengthening in the timing of the signal traveling along the outside conductor relative to the timing of the signal traveling along the inside conductor. Such a lengthening in the timing between the differential signals degrades the signal integrity and can compromise the ability of the cable to perform within the signal integrity specifications typically specified for cable bends.

Cables are typically required to maintain adequate signal integrity around a bend less than 5× the outer diameter of the cable. Twinax cable assemblies 100 typically include multiple cables 104 formed into a bundle. The twinax cables 104 terminate at connectors that plug into electronic equipment, such as backplanes of servers and other computing equipment. In example implementations described below, multiple twinax cables 104 may be arranged as twinax cable sets with the cables disposed side by side with the conductor pairs aligned along the lateral axis A_{LAT}. The twinax cables 104 are typically terminated on a printed circuit board, or other structure in a connector component, in a horizontal configuration such that the conductor pairs connect to a planar surface along the same lateral axis A_{LAT}.

When a bundle of twinax cables 104 exits from a connector shell, each cable 104 exits in a generally horizontal configuration, whereby the lateral axis A_{LAT} of the twinax cable 104 is generally parallel with top or bottom surfaces of the connector shell and/or top or bottom surfaces of the connector printed circuit board. The reason for this is that twinax cables 104 are terminated in a horizontal configuration, since the pair of the conductors 150 connect to a planar surface of the connector printed circuit board which is aligned along the same lateral axis A_{LAT} as the twinax cables 104. However, in this horizontal configuration, a good-way bend is only permissible in a vertical direction D_{V} and not in a horizontal direction D_{H}.

In order to allow for a good-way bend of the twinax cables 104 in a horizontal direction D_{H} upon exiting the connector shell, the present disclosure suggests that the twinax cables 104 exit the connector shell in a generally vertical configuration, in some embodiments, with the aid of a vertical tie bar within the connector shell that fixes each twinax cable in the connector shell in a vertical configuration before exiting the connector so that each twinax cable exits the connector in a vertical configuration instead of a horizontal configuration.

In the vertical configuration, the lateral axis A_{LAT} of the twinax cables 104 is generally perpendicular with top or bottom surfaces of the connector shell and/or top or bottom surfaces of the connector printed circuit board. In the vertical configuration, opposing flat sides of the connector shell are also generally perpendicular with top or bottom surfaces of the connector shell and/or top or bottom surfaces of the connector printed circuit board. Exiting the connector shell in a vertical configuration allows for a good-way bend of each twinax cable in a horizontal direction D_{H} without signal degradation since both conductors within each twinax cable are disposed equidistant from a bending axis around which the cable is bent.

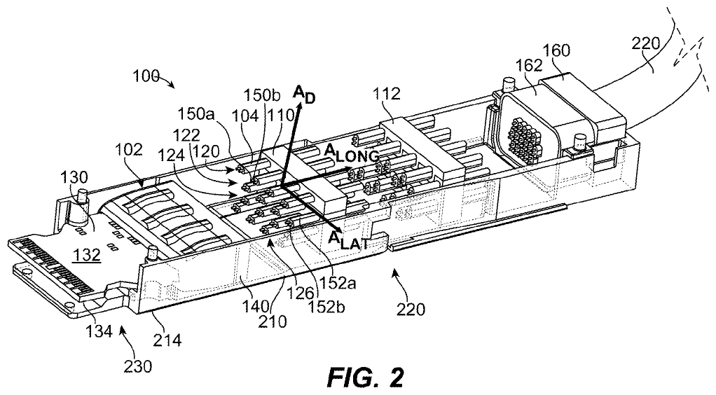

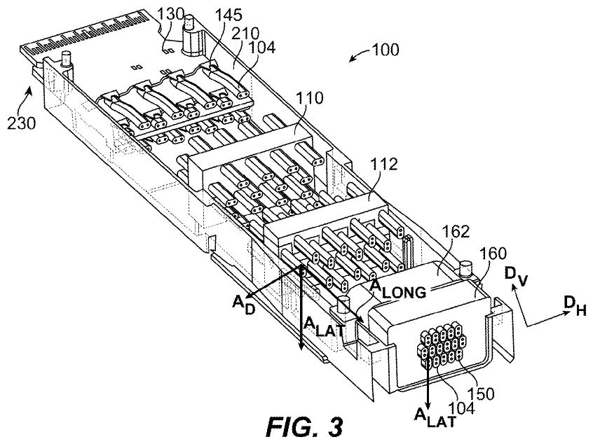

FIG. 2 illustrates an example embodiment of a twinax cable assembly 100 configured for a good-way bend of each twinax cable in a horizontal direction D_{H}, either left or right, upon exiting the connector 200 without substantial degradation of signal integrity. FIG. 3 illustrates a rear perspective view of the twinax cable assembly 100 of FIG. 2 wherein the twinax cables 104 exit the connector 200 in a vertical configuration.

Referring collectively to FIGS. 2 and 3, the twinax cable assembly 100 includes a connector 200 having a connector shell 210 which houses a connector printed circuit board 134 connected to rows 120, 122, 124, 126 of twinax cables 104, a shielding cover 140 which covers the area at which the connector printed circuit board 134 is connected to rows 120, 122, 124, 126 of twinax cables 104, a horizontal tie bar 110 for maintaining the rows 120, 122, 124, 126 of twinax cables 104 in a horizontal configuration, a vertical tie bar 112 for maintaining the rows 120, 122, 124, 126 of twinax cables 104 in a vertical configuration, and a condensing cable tie bar 160 through which the rows 120, 122, 124, 126 of twinax cables 104 exit the connector shell 210.

The twinax cable assembly 100 shown in FIG. 2 includes a plurality of twinax cable rows or sets 120, 122, 124, 126 having a plurality of twinax cables 104, each comprising a pair of conductors 150a and 150b spaced apart in a lateral direction along the lateral axis A_{LAT} depicted for each twinax cable set 120, 122, 124, and 126 by parallel line A_{LAT}. The conductor pairs 150a and 150b within each twinax cable 104 are surrounded by an insulating material.

The example twinax cable assembly 100 in FIGS. 2 and 3 includes the horizontal tie bar 110, the vertical tie bar 112, and the condensing cable tie bar 160. The horizontal tie bar 110 is mounted in the connector shell 210 downstream of the connector printed circuit board 130 in order to maintain each twinax cable 104 in a horizontal configuration. The twinax cable 104 is maintained in a horizontal configuration when the lateral axis A_{LAT}, and/or opposing flat sides 152a, 152b of the twinax cable 104, are generally parallel with top or bottom surfaces 212, 214 of the connector shell 210 and/or top or bottom surfaces 132, 134 of the connector printed circuit board 130.

In this horizontal configuration, a good-way bend is only permissible in the vertical direction D_{V}, upwards or downwards, and about the lateral axis A_{LAT} and not about the depth axis A_{D}. The horizontal tie bar 110 maintains each twinax cable 104 in a horizontal configuration for proper orientation and positioning for mounting each twinax cable 104 onto the connector printed circuit board 130, as shown in FIG. 2, as each twinax cable 104 mounts on the circuit board 130 in a horizontal configuration so as to more easily allow connecting each conductor 150a, 150b to the connector printed circuit board 130.

The vertical tie bar 112 is mounted in the connector shell 210 downstream of the connector printed circuit board 130 in order to orient each twinax cable 104 in a vertical configuration before the cables exit the connector 200. In the current embodiment, the vertical tie bar 112 is also mounted in the connector shell 210 downstream of the horizontal tie bar 110 in order to orient each twinax cable 104 in a vertical configuration.

In one embodiment, the connector 200 does not have a vertical tie bar and instead relies on the condensing cable tie bar 160 to orient the twinax cables in a vertical configuration. Upon traveling downstream from the connector printed circuit board 130 and the horizontal tie bar 110, the orientation of the twinax cable 104 is changed from a horizontal configuration to a vertical configuration before entering the vertical tie bar 112 when opposing flat sides 152a, 152b of the twinax cable 104 are generally perpendicular with top or bottom surfaces 212, 214 of the connector shell 210 and/or top or bottom surfaces 132, 134 of the connector printed circuit board 130.

In the vertical configuration, the lateral axis A_{LAT} of the twinax cable 104 is generally perpendicular with top or bottom surfaces 212, 214 of the connector shell 210 and/or top or bottom surfaces 132, 134 of the connector printed circuit board 130. In this vertical configuration, a good-way bend is now permissible in a horizontal direction D_{H}, left or right, and about the lateral axis A_{LAT}. The vertical tie bar 112 maintains each twinax cable 104 in a vertical configuration for proper orientation and positioning for directing each twinax cable 104 through the condensing cable tie bar 160, as shown in FIG. 2.

The horizontal tie bar 110 and the vertical tie bar 112 are formed with an overmold layer over each twinax cable row 120, 122, 124, 126. For example, twinax cable row 126 is routed through the connector 200 and connected with circuit board 130. Upon routing twinax cable row 126 into the connector shell 210, tooling is placed within the cavity of the connector shell 210 which maintains the cables 104 within the twinax cable row 126 in a horizontal configuration. A horizontal overmold layer, which is part of the horizontal tie bar 110, is formed over the twinax cable row 126 made from low pressure overmold materials to affix the twinax cables 104 in a horizontal position. Thus, any of the condensing cable tie bars described herein can be formed of a polymer material through an overmold (e.g., an injection overmold) process.

Upon connecting twinax cable row 126 to circuit board 130, tooling is placed within the cavity of the connector shell 210 which maintains the cables 104 within the twinax cable row 126 in a vertical configuration. A vertical overmold layer, which is part of the vertical tie bar 112, is formed over the twinax cable row 126 to affix the twinax cables 104 in a horizontal position. Each subsequent twinax cable row 124, 122, 120 also has subsequent horizontal and vertical overmold layers formed on them in order to affix them in either horizontal or vertical position. The horizontal overmold layers form the horizontal tie bar 110 and the vertical overmold layers form the vertical tie bar 112. Each tie bar 110, 112 is configured to orient the plurality of twinax cable sets 120, 122, 124, 126 such that each twinax cable set 120, 122, 124, 126 is stacked on each next twinax cable set 120, 122, 124, 126 substantially parallel to each other within the connector shell 210.

The condensing cable tie bar 160 is mounted at an end of connector shell 210 opposed to and downstream the connector printed circuit board 130 and orients each twinax cable 104 in a vertical configuration. The condensing cable tie bar 160 brings the four rows 120, 122, 124, 126 of twinax cables 104 together in a condensed orientation whereby the twinax cable 104 are in a compacted and adjacent arrangement as shown in FIG. 2. This compacted and adjacent arrangement allows for the twinax cables 104 to be placed compactly in a cable cover or sheath 220 for routing to another location such as another connector or a printed circuit board. A copper shield 162 preferably surrounds the bundled twinax cables 104 that have entered the condensing cable tie bar 160. The copper shield 160 makes compressive contact with the connector shell 210 for providing grounding.

With reference to FIG. 3, the bundled twinax cables exit the condensing cable tie bar 160 in a vertical configuration in order to allow for a good-way bend of the twinax cables in a horizontal direction D_{H} upon exiting the connector shell 210, so that each twinax cable 104 exits the connector shell 210 in a vertical configuration instead of a horizontal configuration. Exiting the connector shell 210 in a vertical configuration allows for a good-way bend of each twinax cable in a horizontal direction D_{H} without signal degradation as both conductors within each twinax cable are disposed equidistant from a bending axis AV around which the cable is bent.

The twinax cables in the twinax cable assembly 100 may be any suitable twinax cable having a pair of conductors 150. The twinax cables may be surrounded by a dielectric material to keep the conductors apart while providing some flexibility to permit bending. The conductor pairs and insulation may also be surrounded by a shielding material, such as a metal foil or braided metal in a film-like arrangement. In some embodiments, the twinax cables include a pair of ground wires disposed on opposite sides of the pair of conductors. The pair of conductors 150 and pair of ground wires may be spaced apart and aligned along the lateral axis A_{LAT}.

FIG. 2 is a front perspective view of the twinax cable assembly 100 connected to connector printed circuit board 130. The twinax cable assembly 100 may be any suitable length and may typically be covered by a sheath 220 or a suitable material that keeps the twinax cables encased for convenience in handling when the cables 104 have exited the connector shell 210 at the rear of the shell 210. The printed circuit board 130 may be enclosed in the connector shell 210. The twinax cable sets 120, 122, 124, 126 may be stacked as shown in FIG. 2 in a first order 120-122-124-126 within the connector shell 210 to connect to the printed circuit board 130.

The rows 120, 122, 124, 126 of twinax cables 104 connect to the printed circuit board 130 at a first end of the cable assembly 100. At the first end, the twinax cables 104 may be fixed to the printed circuit board 130 by a bracket 145. A first bracket 145a secures the ends of twinax cable row 120. A second bracket 145b secures the ends of twinax cable row 122. A third bracket 145c secures the ends of twinax cable row 124. A fourth bracket 145d secures the end of twinax cable row 126, and so forth. The conductor pairs 150 in each twinax cable 104 may be soldered, welded, or otherwise functionally secured to a surface 132, 134 of the printed circuit board 130 to electrically connect to a suitable trace etched on the printed circuit board 130. The connections of the conductor pairs 150 may be connected to the printed circuit board 130 in rows according to the stacking order of the twinax cable rows 120, 122, 124, 126.

It is noted that the example twinax cable assembly 100 described with reference to FIGS. 2-3 include terminal connections to printed circuit board 130. It is noted, however, that other example twinax cable assembly 100 implementations may terminate at different structures. A printed circuit board 130 is but one type of terminal structure illustrated here for purposes of providing a clear description. Other suitable connection structures may be used as well.

The connector 200 is at one end 102 of the twinax cable assembly 100. The connector 200 has a connector shell 210 covering the connector printed circuit board 130. The twinax cable assembly 100 is shown covered with a cable cover or sheath 220. The connector 200 may include a suitable mating structure 230 that mates with a corresponding structure on a receiving connector (not shown). The receiving connector may be a part of an electronic component configured to receive the connector 200 and the signals communicated on the twinax cable assembly 100.

It is noted that the example implementations of the twinax cable sets 120, 122, 124, 126 described in this disclosure each include four twinax cables. However, other example implementations may include any other suitable number of twinax cables. In addition, four twinax cable sets 120, 122, 124, 126 form the example twinax cable assemblies 100 described herein, however, other example implementations may include any suitable number of twinax cable sets. In addition, example implementations may include a first plurality of twinax cable sets having one number of twinax cables, and through lacing, come together at the other end with a second plurality of cable sets with a different number of twinax cables in each twinax cable set.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A twinax cable assembly comprising:
a plurality of twinax cable sets, each comprising a plurality of twinax cables, each twinax cable comprising a first conductor spaced apart from a second conductor, each of the twinax cable sets having opposite cable end sections corresponding to first and second assembly ends, and connector ends where each of the twinax cables in the twinax cable sets connect to a terminal component;
a connector having a portion of the plurality of twinax cable sets housed therein, the connector having a connector shell having a connector printed circuit board connected to rows of twinax cables at the connector ends; and
a condensing cable tie bar through which the rows of twinax cables exit the connector shell in a vertical configuration, wherein, in the vertical configuration, the lateral direction of the twinax cables is generally perpendicular to a top or bottom surface of the connector printed circuit board.

2. The twinax cable assembly according to claim 1, wherein the connector further comprises a horizontal tie bar downstream of the connector printed circuit board for maintaining the rows of twinax cables in a horizontal configuration, wherein the connector ends of the twinax cables are coupled to the connector printed circuit board in the horizontal configuration.

3. The twinax cable assembly according to claim 2, wherein the connector further comprises a vertical tie bar downstream from the horizontal tie bar for maintaining the rows of twinax cables in a vertical position.

4. The twinax cable assembly according to claim 1, wherein each twinax cable comprises a pair of ground wires disposed on opposite sides of the pair of conductors, the pair of conductors and pair of ground wires spaced apart in the lateral direction.

5. The twinax cable assembly according to claim 1, where the pair of conductors at the connector ends of each twinax cable set connect to the connector printed circuit board in a row of connections substantially in parallel with the row of connections at which the connector ends of a next twinax cable set connects to the connector printed circuit board.

6. The twinax cable assembly according to claim 1, wherein the first conductor and the second conductor are spaced apart from one another in a lateral direction.

7. The twinax cable assembly according to claim 2, wherein the condensing cable tie bar and the horizontal tie bar are each formed of an injection-molded polymer material.

8. A twinax cable assembly comprising:
a plurality of twinax cable sets, each comprising a plurality of twinax cables, each twinax cable comprising a first conductor spaced apart from a second conductor and surrounded by an insulating material, each of the twinax cable sets having opposite cable end sections corresponding to first and second assembly ends, and connector ends where each of the twinax cables in the twinax cable sets connect to a terminal component;
a connector housing a portion of the plurality of twinax cable sets, the connector having a connector shell which houses a termination structure connected to rows of twinax cables at a cable end section and a condensing cable tie bar through which the rows of twinax cables exit the connector shell in a vertical configuration,
wherein in the vertical configuration, the lateral direction of the twinax cable is generally perpendicular to a top or bottom surface of the termination structure.

9. The twinax cable assembly according to claim 8, wherein the termination structure is a connector printed circuit board.

10. The twinax cable assembly according to claim 9, wherein the connector further comprises a horizontal tie bar downstream of the connector printed circuit board for maintaining the rows of twinax cables in a horizontal configuration.

11. The twinax cable assembly according to claim 10, wherein the connector further comprises a vertical tie bar downstream from the horizontal tie bar for maintaining the rows of twinax cables in a vertical position.

12. The twinax cable assembly according to claim 8, wherein each twinax cable comprises a pair of ground wires disposed on opposite sides of the pair of conductors, the pair of conductors and pair of ground wires spaced apart in the lateral direction.

13. The twinax cable assembly according to claim 9, where the pair of conductors at the connector ends of each twinax cable set connect to the connector printed circuit board in a row of connections substantially in parallel with the row of connections at which the connector ends of a next twinax cable set connects to the connector printed circuit board.

14. The twinax cable assembly according to claim 8, wherein the first conductor and the second conductor are spaced apart from one another in a lateral direction.

15. The twinax cable assembly according to claim 10, wherein the condensing cable tie bar and the horizontal tie bar are each formed of an injection-molded polymer material.

16. A twinax cable assembly comprising:
a plurality of twinax cable sets, each comprising a plurality of twinax cables, each twinax cable comprising a first conductor spaced apart from a second conductor and surrounded by an insulating material, each of the twinax cable sets having opposite cable end sections corresponding to first and second assembly ends, and connector ends where each of the twinax cables in the twinax cable sets connect to a terminal component;
a connector housing a portion of the plurality of twinax cable sets, the connector having a connector shell which houses a termination structure connected to rows of twinax cables at a cable end section;
a vertical tie bar through which the rows of twinax cables exit in a vertical configuration disposed in the connector housing; and
a horizontal tie bar through downstream of the vertical tie bar which the rows of twinax cables exit in a horizontal configuration disposed in the connector housing, wherein the plurality of twinax cables are coupled to the termination structure in the horizontal configuration.

17. The twinax cable assembly according to claim 16, wherein the termination structure is a connector printed circuit board, and further comprising: a condensing cable tie bar disposed in the connector housing through which the rows of twinax cables exit the connector shell in a vertical configuration.

18. The twinax cable assembly according to claim 16, wherein each twinax cable comprises a pair of ground wires disposed on opposite sides of the pair of conductors, the pair of conductors and pair of ground wires spaced apart in the lateral direction.

19. The twinax cable assembly according to claim 17, where the pair of conductors at the connector ends of each twinax cable set connect to the connector printed circuit board in a row of connections substantially in parallel with the row of connections at which the connector ends of a next twinax cable set connects to the connector printed circuit board.

20. The twinax cable assembly according to claim 16, wherein the first conductor and the second conductor are spaced apart from one another in a lateral direction, and the vertical tie bar and the horizontal tie bar are each formed of an injection-molded polymer material.
